(19) United States
(12) Patent Application Publication
(10) Pub. No.: US 2006/0024052 A1
(43) Pub. Date: Feb. 2, 2006

(54) Image forming apparatus

(75) Inventor: Futoshi Yoshida, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/185,740

(22) Filed: Jul. 21, 2005

(30) Foreign Application Priority Data
Jul. 28, 2004 (JP) 2004-220313
May 30, 2005 (JP) 2005-157940

(51) Int. Cl. G03B 13/00

(52) U.S. Cl. 396/571

(57) ABSTRACT

An image forming apparatus is provided which can be made smaller in the vertical direction and in which arrangement of a photosensitive material drying device has an increased degree of freedom so that a leading end of a photosensitive material is not damaged even when a pull-in angle when the photosensitive material made to intrude into an endless belt of the drying device becomes larger, the endless belt including a mesh structure in which warps extending along a direction in which the photosensitive material is conveyed are intersect with wefts, and in which at least in a region of the endless belt on which region the photosensitive material is placed, at least a portion of the warp is positioned nearer a surface of the photosensitive material, which surface faces the endless belt, than the weft in each portion at which the weft intersects with the warp.

### CROSS-REFERENCE TO RELATED APPLICATION

This application claims priority under 35 USC 119 from Japanese Patent Applications Nos. 2004-220313 and 2005-157940, the disclosures of which are incorporated by reference herein.

### BACKGROUND OF THE INVENTION

1. Field of the Invention

The present invention relates to an image forming apparatus equipped with a photosensitive material drying device in which, after a photosensitive material such as photographic printing paper, on which a latent image is formed by exposure, is subjected to liquid processing for color development, bleach-fix, and water washing so as to visualize a latent image, the photosensitive material wet with the processing solution is dried.

2. Description of the Related Art

As an image forming apparatus such as a printer processor, a so-called digital mini laboratory (mini-lab) has been generally known in which scan-exposure is carried out for a photosensitive material such as photographic printing paper in such a manner that the photosensitive material is irradiated with a laser beam from a laser exposure section, which laser beam is modulated correspondingly to image information, and thereafter, is subjected to liquid processing for color development, bleach-fix, and water washing, and the photosensitive material (photographic printing paper) wet with the processing solution is subjected to drying processing in a drying section, with the result that a finished product of photosensitive material having an image formed thereon.

In the drying section of such a digital minilab (an automatic processor), when photographic printing paper is conveyed with nip rollers, stagger patterned rollers, or the like being brought into contact with a photosensitive emulsion surface of the photographic printing paper, there are cases in which damage caused by the rollers making contact with the photosensitive emulsion surface, pressing marks made by the rollers on the photosensitive emulsion surface, uneven surface gloss on the photosensitive emulsion surface, and the like may occur. Particularly, when the photographic printing paper is conveyed in contact with the rollers in a semi-dried state, these phenomena become more striking.

Accordingly, a conventional photosensitive material drying device has been proposed in which, an air blowing plate including a large number of slits formed thereon is provided in an air blowing case and a mesh-endless belt that forms a belt conveyor is disposed so as to face the air blowing plate, a photographic printing paper is fed into a region between the air blowing plate and the endless belt, a state in which the photographic printing paper is pressed against and placed on the surface of the endless belt by blowing dry air from the air blowing case against the photographic printing plate is maintained, and the photographic printing paper is dried during conveyance of the photographic printing paper, together with make-a-round operation of the endless belt, in a state in which the photographic printing paper is not contact with the air blowing plate (see Japanese Patent Application Laid-Open (JP-A) No. 2000-155404).

In the photosensitive material drying device as described above, in order that photographic printing paper may be smoothly conveyed between the air blowing plate and the endless belt by setting a pull-in angle (an angle of intrusion) small when the photographic printing paper is pulled in a region between the air blowing plate and the endless belt (by setting such that “a conveying path of the endless belt” and “the upstream-side positioned conveying path with respect to the photosensitive material drying device” are positioned substantially on a straight line), a conveying path for an operation of “pulling out the photographic printing paper from liquid tanks (for liquid processing for color development, bleach-fix, and water washing) in the vertical direction, and squeezing off the processing solution from the photographic printing paper by squeeze rollers, and effecting drying processing for the photographic printing paper in the photosensitive material drying device” is designed so as to extend in a straight. In other words, the conveying path is formed so that an angle formed by the direction in which the photographic printing paper is conveyed from the squeeze rollers (conveying direction of the upstream-side positioned conveying path with respect to the photosensitive material drying device) and the conveying direction of the endless belt (the conveying direction in the photosensitive material drying device) is lessened as far as possible.

In the above-described structure, there is a restriction that squeeze rollers and a relatively elongated photosensitive material drying device should be disposed so as to extend from the upper portion of the liquid tanks (used for liquid processing for development and the like) in the vertical direction, and therefore, the image forming apparatus would result in a larger size in the vertical direction.

Further, in the image forming apparatus as described above, when the photosensitive material drying device is intended to be laid down (intended to extend in the horizontal direction) so as to prevent the apparatus from becoming larger in the vertical direction, the pull-in angle (the angle of intrusion) at the time in which the photographic printing paper is intruded into between the air blowing plate and the endless belt of the photosensitive material drying device becomes larger. For this reason, when the leading end of the photographic printing paper abuts against a mesh (a stitch) of the mesh-endless belt, there exists a drawback that the photographic printing paper may be damaged, for example, the photographic printing paper may suffer a slip or may be entangled with the stitches.

### SUMMARY OF THE INVENTION

In view of the above-described drawbacks, the present invention provides an image forming apparatus that can be made smaller in the vertical direction in such a manner in which a predetermined angle is formed between a direction in which a photosensitive material is conveyed at the upstream-side positioned conveying path with respect to a photosensitive material drying device and a direction in which the photosensitive material is conveyed at the photosensitive material drying device, and that can prevent a leading end of the photosensitive material from being damaged even if a pull-in angle at a time in which the photosensitive material is intruded into an endless belt of the photosensitive material drying device is larger.

A first aspect of the present invention is an image forming apparatus equipped with a drying device, the drying device having a conveying system for conveying a photosensitive material, at which an endless belt is wound on a plurality of winding rollers, and an air blowing section for drying a photosensitive material on the endless belt by blowing dry air against the endless belt, wherein the photosensitive material can be conveyed by the endless belt in a state in which the photosensitive material is pressed and maintained on the endless belt by means of dry air, and wherein the endless belt includes a mesh structure in which warps extending along a direction in which the photosensitive material is conveyed intersect with wefts, and at least in a region of the endless belt on which region the photosensitive material is placed, at least a portion of the warp is positioned nearer a surface of the photosensitive material, which surface faces the endless belt, than the weft in each portion at which the weft intersects with the warp.

Due to the above-described structure, at least in the region of the endless belt on which region the photosensitive material is placed, at least a part of the warp is surely mounted on the weft in a photosensitive material side which side faces and contacts the endless belt, in each of portions at which the wefts intersect with the warps (at least a part of the warp is positioned nearer the surface of the photosensitive material, which surface faces the endless belt, than the weft in each of portions at which the wefts intersect with the warps). In other words, in the longitudinal direction of the warp, although irregularities (convex portions) may be generated in portions at which the warp and the weft intersect with each other, the surface of the warp extends continuously. Accordingly, at least in the region of the endless belt at which the photosensitive material is placed on the endless belt, there is no portion in which the weft is placed on the surface of the warp so as to protrude from the warp, in the longitudinal direction. In the endless belt having the above-described structure, even when the leading end of the photosensitive material intrudes into the endless belt, for example, at a severe intrusion angle, it slides on the warps of the endless belt and can be prevented from being damaged in such a manner as to be caught in the weft. Therefore, the drying device can be disposed in such a manner in which a predetermined angle is formed between a direction in which the photosensitive material is conveyed at the upstream-side positioned conveying path with respect to the photosensitive material drying device and a direction in which the photosensitive material is conveyed at the photosensitive material drying device. Accordingly, the image forming apparatus can be made smaller in the vertical direction. In addition, even if the angle of intrusion when the photosensitive material is intruded into the endless belt of the photosensitive material drying device becomes larger, the leading end of the photosensitive material can be prevented from being damaged.

In a second aspect of the present invention according to the first, when the photosensitive material abuts against and intrudes into the endless belt in the conveying system of the drying device, a conveying speed of the endless belt is made higher than a conveying speed of a conveying passage by which the photosensitive material is conveyed into the drying device.

Due to the above-described structure, in addition to the operation and effect of the invention described in the first aspect, when the leading end of the photosensitive material abuts against and intrudes into the endless belt from the conveying passage by which the photosensitive material is conveyed into the drying device, the leading end of the photosensitive material makes contact with the endless belt in a state in which the photosensitive material slowly slides on the continuously extending warps of the endless belt, the conveying speed thereof being set higher, thereby reducing impact at the time of intrusion of the photosensitive material into the endless belt. As a result, it is possible to more reliably reduce the possibility that the leading end of the photosensitive material may be damaged.

In a third aspect of the present invention according to the first aspect, the warp comprises a plurality of yarns.

In a fourth aspect of the present invention according to the third aspect, the warp is formed by weaving a plurality of twisted yarns.

In a fifth aspect of the present invention according to the third aspect, the weft passes through between the plurality of yarns of the warp in each portion at which the weft intersects with the warp.

In a sixth aspect of the present invention according to the first aspect, the warp is mounted onto the weft so as to be positioned nearer the surface of the photosensitive material than the weft in each portion at which the weft intersects with the warp.

In a seventh aspect of the present invention according to the sixth aspect, the warp is fixed to the weft by an adhesive member.

The image forming apparatus of the present invention has excellent effects that the image forming apparatus can be made smaller in the vertical direction in such a manner in which a predetermined angle is formed between a direction in which a photosensitive material is conveyed at the upstream-side positioned conveying path with respect to a photosensitive material drying device and a direction in which the photosensitive material is conveyed at the photosensitive material drying device, and the device can prevent a leading end of the photosensitive material from being damaged even if a pull-in angle at a time in which the photosensitive material is intruded into an endless belt of the photosensitive material drying device is larger.

### BRIEF DESCRIPTION OF THE DRAWINGS

FIG. 1 is a structural diagram schematically showing a digital laboratory system according to an embodiment of the present invention.

FIG. 2 is an enlarged structural diagram schematically showing a portion including a drying device used in the digital laboratory system according to the embodiment of the present invention.

FIG. 3 is an enlarged perspective view showing a portion of an endless belt used in the drying device for the digital laboratory system according to the embodiment of the present invention.

FIG. 4 is an enlarged sectional view showing the endless belt used in the drying device for the digital laboratory system according to the embodiment of the present invention.

FIG. 5 is an enlarged perspective view showing a portion of an endless belt having other structure, which is used in the drying device for the digital laboratory system according to the embodiment of the present invention.

FIG. 6 is an enlarged perspective view showing a portion of an air blowing plate used in the drying device for the digital laboratory system according to the embodiment of the present invention.

FIG. 7 is an enlarged sectional view showing a ventilation hole portion of the air blowing plate used in the drying device for the digital laboratory system according to the embodiment of the present invention.

FIG. 8 is an enlarged sectional view showing a structure of a comparative example of the ventilation hole portion of the air blowing plate used in the drying device for the digital laboratory system.

FIG. 9 is a table showing the relationship between spring pressure of nip rollers, and conveying property, which nip rollers are used in the drying device for the digital laboratory system according to the embodiment of the present invention.

FIG. 10 is a table showing the relationship between spring pressure of nip rollers, and damage to photographic printing paper, which nip rollers are used in the drying device for the digital laboratory system according to the embodiment of the present invention.

### DETAILED DESCRIPTION OF THE INVENTION

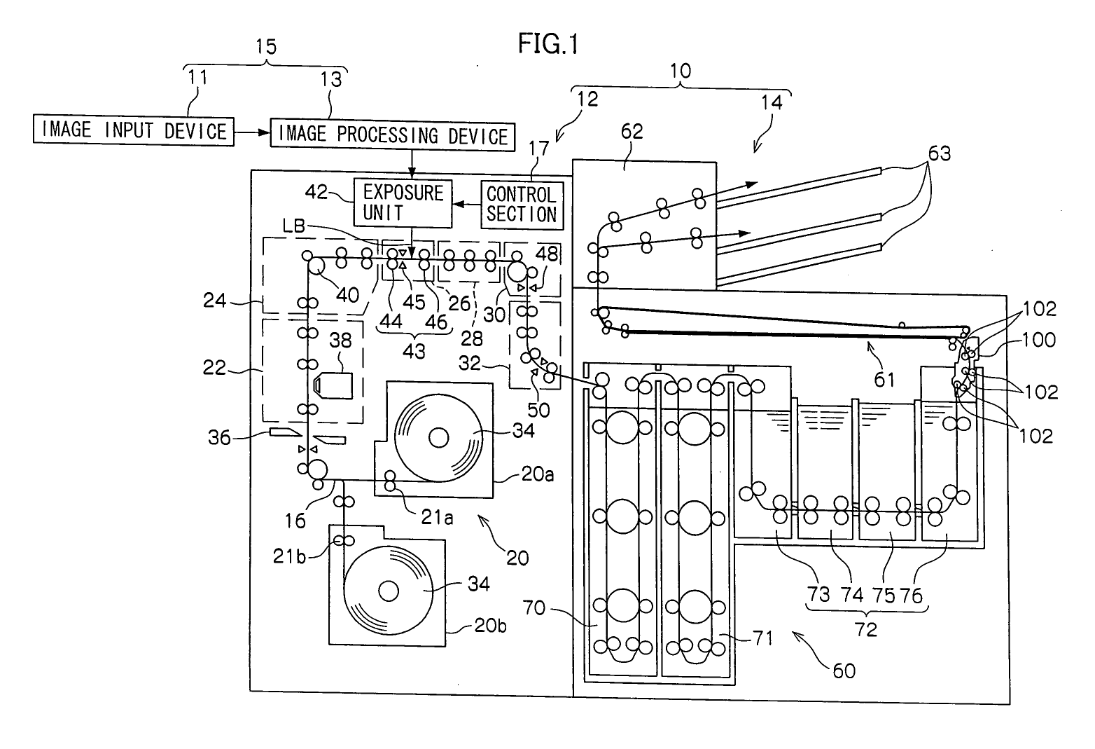

Referring now to FIGS. 1 to 10, an image forming apparatus according to an embodiment of the present invention will be described hereinafter. The image forming apparatus (printer-processor) according to the present embodiment serves as an output machine 10 for a so-called digital laboratory system.

This digital laboratory system is structured by a combination of an input machine 15 equipped with an image input device 11 and an image processing device 13, and an output machine 10 equipped with a laser printer section 12 and a processor section 14.

The image input device 11 in the input machine 15 is used to photo-electrically read, using an imaging element such as a CCD image sensor, a film image recorded on a photographic film such as a negative film or a reversal film (projection-light of the film image), and film images on various sizes of photographic films are to be read by the image input device. In the image input device 11, image data is generated by photo-electrically reading the projection-light of the film image to be read recorded on the photographic film, using the CCD image sensor or the like, or image data is acquired by reading image data recorded on a recording medium such as a memory card, or image data is acquired by receiving image data from other information processing equipment via a communication line. The image data thus generated or acquired is forwarded from the image input device 11 to the image processing device 13.

In the image processing device 13, recording image data is generated by carrying out image processing such as color balance correction, density correction and the like, for the inputted image data, and is outputted to the laser printer section 12 of the output machine 10.

The laser printer section 12 in the output machine 10 is equipped with laser light sources which emit laser beams of red (R), green (G) and blue (B). The photographic printing paper that serves as a photosensitive material is subjected to scan-exposure by being irradiated with laser beams modulated in accordance with the recording image data inputted from the image processing section of the input machine, and a latent image is thereby formed on the photographic printing paper.

In the processor section 14 of the output machine 10, the photographic printing paper on which a latent image has been formed in the laser printer section 12 is subjected to liquid processing for color development, bleach-fix, and water washing, and thereafter, further subjected to drying processing. As a result, a finished product of photographic printing paper in which an image has been visualized is obtained.

As shown in FIG. 1, the laser printer section 12 in the output machine 10 carries out image recording by laser beams (recording lights) whose intensities are modulated based on image data, while conveying cut recording paper which is cut to a predetermined length. In the laser printer section 12, a sheet feeding section 20, a backside printing section 22, a registration section 24, an image recording section 26, a sub-scan receiving section 28, a sorting section (an arranging section) 30, and a discharging section 32 are provided from the upstream side in the conveying direction on the conveying path 16. A conveying roller pair comprised of a driving roller and a nip roller is provided at each of positions arranged along the conveying path 16 which conveys the cut recording paper serving as photosensitive material (for example, photographic printing paper).

Further, each of components which form the output machine 10 is connected to a control section 17 via wiring (not shown), and the entire operation of the output machine 10 is controlled by the control section 17.

In the sheet feeding section 20 disposed in the laser printer section 12 of the output machine 10, magazines 20a and 20b are set which each contain photosensitive recording paper 34 (photographic printing paper) serving as an elongated photosensitive material wound in a roll. These magazines 20a and 20b are provided with pull-out roller pairs 21a and 21b, respectively, for pulling out the photosensitive recording paper 34 onto the conveying path 16 and conveying the photosensitive recording paper 34 to the backside printing section 22.

A cutter 36 such as a rotary cutter, which is used for cutting the photosensitive recording paper 34, is disposed on the conveying path 16 at a position apart from each exit of the magazines 20a and 20b by a predetermined distance. The cutter 36 is driven by a control signal from the control section 17, and is provided so as to form cut recording paper by cutting the photosensitive recording paper 34 pulled out by a predetermined length according to a print size. Examples of the print size include L (89×127), panorama (89×254), 2L (127×178), octavo (165×216), sixmo (203×254), quarto (254×305), and the like. In the present embodiment, for example, cut recording papers whose transverse dimensions in a direction perpendicular to the conveying direction are 89, 95, 102, 117, 120, 127, 130, 152, 165, 178, 203, 210, 216, 254 and 305 are intended. These dimensions are all shown on the millimeter scale.

The backside printing section 22 is provided with a backside print head 38 for recording, on a non-recording surface of the cut recording paper (a surface opposite to the exposure surface), print information including a date of photographing, date of printing, frame number, various IDs, and the like. As the backside printing head 38, known print heads such as a dot impact head, an ink jet head, a heat-transfer print head and the like can be used as long as they are resistant to subsequent wet development processing.

The registration section 24 is formed by a registration roller pair 40 for adjusting the tilt of the cut recording paper and the position thereof in the transverse direction, and a plurality of conveying roller pairs disposed in the vicinities of the registration roller pair 40, so as to prevent displacement of exposure position and angular displacement in the image recording section 26. As a method for adjusting the tilt and the position of the cut recording paper in the transverse direction by the registration roller pair 40, known methods such as a tilt registration, a top registration, and a side registration can be used.

The image recording section 26 includes an exposure unit 42, a sub-scan section 43 provided with roller pairs 44 and 46, and a recording paper sensor 45 for detecting passing of the cut recording paper, and the operation of the image recording section 26 is controlled by the control section 17.

The exposure unit 42 is connected to the image processing device 13. When the recording paper sensor 45 detects that the leading end of the cut recording paper has passed, laser beams LB of red, green and blue, of which intensities are modulated based on image data, are made to scan in the main scanning direction (a direction perpendicular to the conveying direction), and a latent image is recorded on the cut recording paper.

The sub-scan section 43 is disposed adjacent to the lower portion of the exposure unit 42 in an integrated manner. The sub-scan roller pairs 44 and 46 of the sub-scan section 43 are disposed respectively at the upstream side and downstream side in the conveying direction, with an exposure-light irradiation position by the light beams LB (that is, an exposure position) interposed therebetween, and conveys the cut recording paper to the exposure-light irradiation position in the sub-scan direction (a direction parallel to the conveying direction) at a predetermined speed. The nip rollers of the sub-scan roller pairs 44 and 46 are formed so as to move between the position at which the cut recording paper is nipped thereby, and the position at which the nip rollers are separated from the cut recording paper, in a switchable manner. The operation of the nip rollers is switched when the leading end or trailing end of the cut recording paper is detected by a position sensor (not shown). As a result, it is possible to prevent the leading end of the cut recording paper from striking against the sub-scan roller pair 46 provided at the downstream side, or prevent the cut recording paper from suffering excessive impact when the trailing end of the cut recording paper is pulled out from the sub-scan roller pair 44 provided at the upstream side.

The sub-scan receiving section 28 is equipped with a plurality of roller pairs for holding the leading end of the cut recording paper forwarded from the image recording section 26 during an image recording operation, and discharges the cut recording paper to the downstream side at the same speed as the conveying speed in the image recording section 26. Each roller pair of the sub-scan receiving section 28 is comprised of a drive roller and a nip roller that is capable of releasing the state of nipping the paper. After the leading end of the cut recording paper on which an image is in the process of being recorded has passed, these roller pairs nip the cut recording paper. As a result, it is possible to prevent variation in the conveying speed, resulting from that the leading end of the cut recording paper strikes against the rollers.

The sorting section 30 is provided so as to arrange cut recording papers, which have been conveyed in a single line, in two lines in the main scanning direction while conveying these papers at a predetermined first speed. Further, the discharging section 32 discharges the cut recording paper forwarded from the sorting section 30, to the processor section 14 while conveying these papers at a second speed corresponding to the processing speed of the processor section 14. The sorting section 30 and the discharging section 32 are respectively provided with sensor sections 48 and 50 which are used to detect the presence or absence of cut recording paper. These sensor sections 48 and 50 each may be formed by, for example, an optical sensor comprised of a light emitting diode and a photo diode. Each output of the sensor sections 48 and 50 varies only a period in which the cut recording paper is passing between the light emitting diode and the photo diode. Therefore, the leading end or trailing end of the cut recording paper can be detected using the sensor sections 48 and 50.

The processor section 14 in the output machine 10 includes a development processing section 60, a drying device 61, a re-sorting section 62, and a sorter 63. In the development processing section 60, a development tank 70, a bleach-fix tank 71, and a water washing tank section 72 comprised of a first washing tank 73, a second washing tank 74, a third washing tank 75 and a fourth washing tank 76 are provided. The development tank 70 is filled with a predetermined amount of developing solution, and the bleach-fix tank 71 is filled with a predetermined amount of bleach-fix solution. Further, the first, second, third and fourth water washing tanks 73, 74, 75 and 76 are each filled with a predetermined amount of washing water. The cut recording paper is subjected to liquid processing for development, bleach-fix and washing in such a manner as to be conveyed by driving force of conveying racks respectively provided in the first development tank 70, the bleach-fix tank 71, and the first to fourth washing tanks 73, 74, 75 and 76 through these processing tanks 70, 71 and 72.

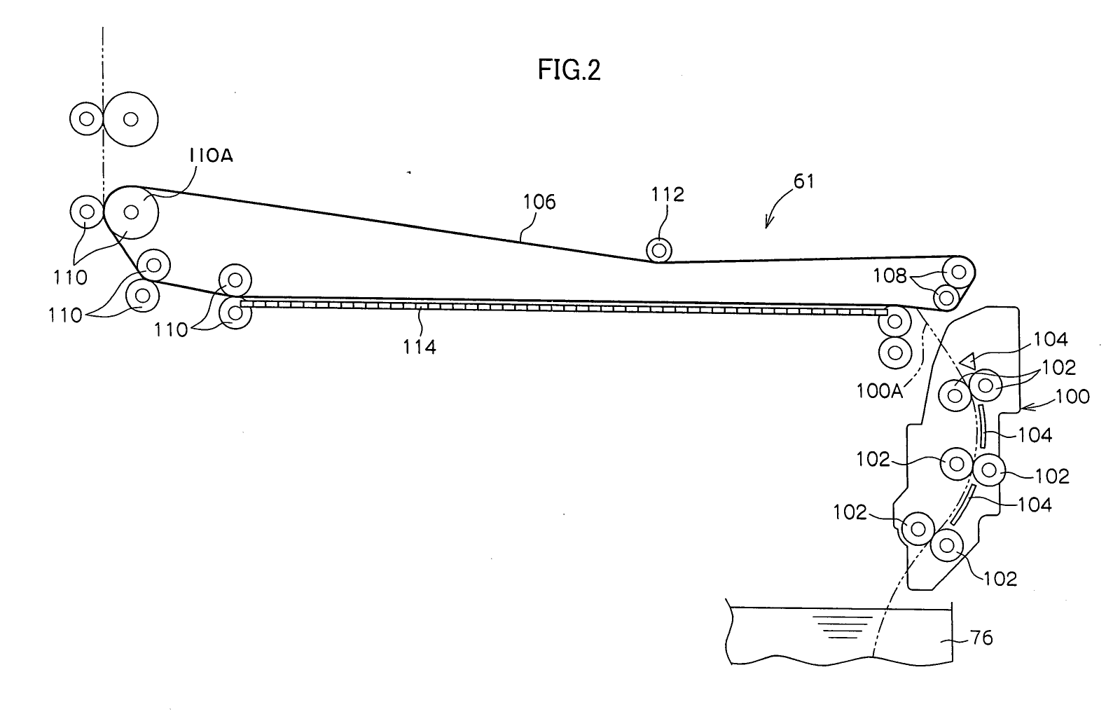

As shown in FIGS. 1 and 2, the cut recording paper having been subjected to liquid processing and wet with the washing solution is conveyed on the conveying path 16 extending upward from the fourth washing tank 76, and is sent in a squeezing device 100. Washing water adhering to the surface of the cut recording paper is squeezed off by squeezing rollers 102.

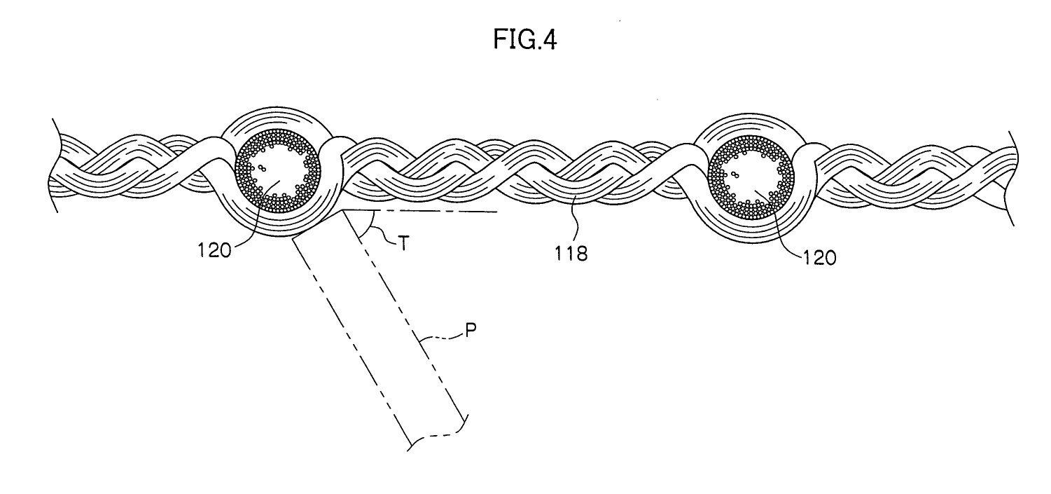

In this squeezing device 100, a conveying passage 100A for conveying the cut recording paper to the drying device 61 is formed by arranging a plurality of squeezing rollers 102 and a plurality of transport guide members 104 on the conveying path. The conveying passage 100A of the squeezing device 100 is formed such that the angle of intrusion T (see FIG. 4) at which the leading end of the cut recording paper abuts against the surface of the endless belt 106 structuring the conveying passage of the drying device 61 becomes 60 degrees or less.

Experiment has shown that when the angle of intrusion T at which the leading end of the cut recording paper abuts against an object (in this case, the endless belt 106) is 60 degrees or less, the leading end of the cut recording paper is not damaged.

As shown in FIGS. 1 and 2, in the processor section 14, the drying device 61 is disposed so as to extend in a substantially horizontal direction in a space above the processing tanks 70, 71 and 72. In this way, due to the processor section 14 having a layout in which the drying device 61 is laid down above the processing tanks 70, 71 and 72, the processor section 14 can be entirely made smaller with respect to the vertical direction dimension thereof, as compared with a layout in which the drying device 61 that is elongated in the photosensitive material conveying direction is disposed vertically above the fourth washing tank 76. Therefore, a large space above the fourth washing tank 76, which space is required in the layout in which the drying device 61 is disposed vertically above the fourth washing tank 76, is not required in the embodiment.

As shown in FIG. 2, in the drying device 61, the endless belt 106 is disposed in such a manner that the endless belt 106 is wound on two winding rollers 108 at the upstream side of the conveying direction, is nipped by three nip roller pairs 110 serving as winding rollers disposed at the downstream side of the conveying direction, and is made in rolling-contact with a tension pressure adjusting roller 112 so as to receive pressure, thereby allowing a side of the endless belt 106, which side faces the processing tanks 70, 71 and 72, to become a portion of the conveying passage of cut recording paper.

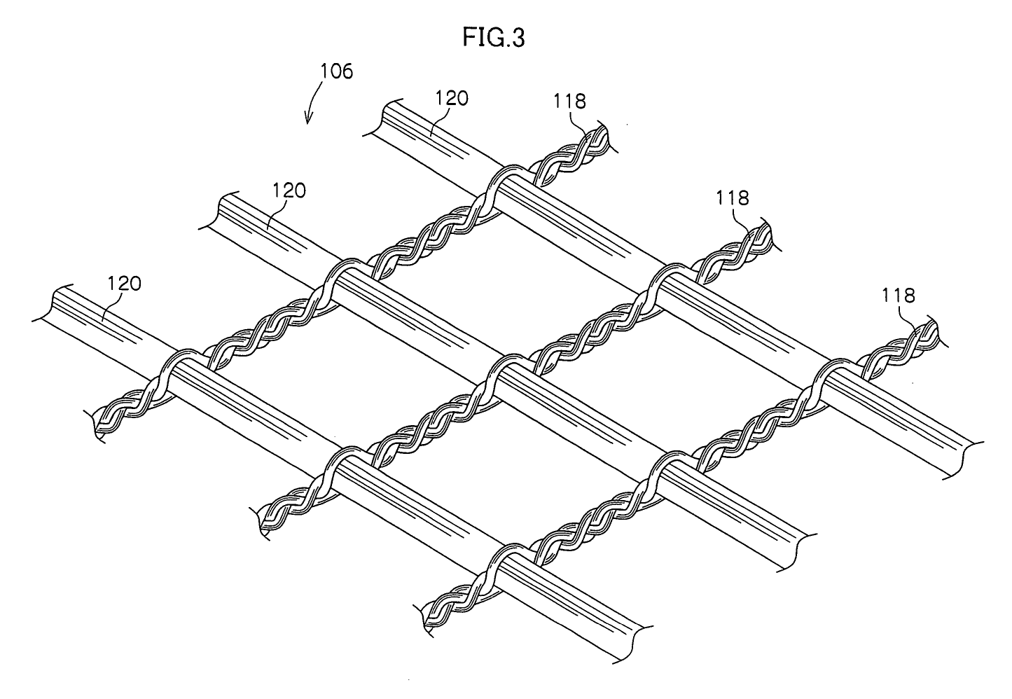

The endless belt 106 serving as the portion of the conveying passage of cut recording paper is, for example, as shown in FIGS. 3 and 4, formed by a mesh material having a rectangular mesh structure (rectangular stitch structure) comprised of a polyester warp 118 and a polyester weft 120. In the mesh material used for the endless belt 106, each of the warp 118 is arranged in the same direction with a predetermined interval therebetween, and each weft 120 is arranged in the direction perpendicular to the direction of the warp 118 with a predetermined interval therebetween. The warp 118 is formed by weaving a plurality of yarns (twisted yarns), and each weft 120 (a single yarn or twisted yarns) is made to pass through each of portions of the warps 118 such that the weft 120 passes through between the plurality of woven yarns at each of the positions of the warps 118, thereby allowing formation of a rectangular mesh structure.

Further, in the endless belt 106, the mesh material is used in such a manner that the warp 118 extends in the conveying direction of the endless belt 106, and the weft 120 extends in the transverse direction of the endless belt 106 (a direction perpendicular to the conveying direction). In other words, the warps 118 are provided, in the state of being formed as the endless belt 106, so as to be disposed substantially parallel to a direction in which the cut recording paper is conveyed.

In the endless belt 106 having the above-described structure, at least one yarn among the plural yarns of the warp 118 is made to surely mount on the weft 120 at each of all positions at which the warp 118 and the weft 120 intersect with each other. That is, as shown in FIG. 4, at the sectional view, the weft 120 is enclosed by the plural yarns of the warp 118. Therefore, at each of all positions at which the warp 118 and the weft 120 intersect, at least a portion of the warp 118 is positioned nearer the cut recording paper than the surface of the weft 120 when set as the endless belt. In other words, in the longitudinal direction of the warp 118, although irregularities are formed (convex and concave portions are formed) on the warp 118 at positions at predetermined intervals, where the weft 120 is made to pass through the warp 118, a surface of the warp 118 extends continuously in the longitudinal direction entirety. Accordingly, in the endless belt 106, the warp 118 is provided as a structure having no portion in which the weft 120 is placed on the surface of the warp 118 in the longitudinal direction in such a manner as to protrude from the warp 118.

In the endless belt 106 as structured above, as shown by the imaginary line in FIG. 4, even when the leading end of the cut recording paper P is intruded at, for example, the intrusion angle of T of 60 degrees, it is possible to prevent the leading end of the cut recording paper from being damaged due to being caught by the weft 120, since the leading end of the paper can move in a sliding manner on the warp 118 of the endless belt 106 because of the structure mentioned above.

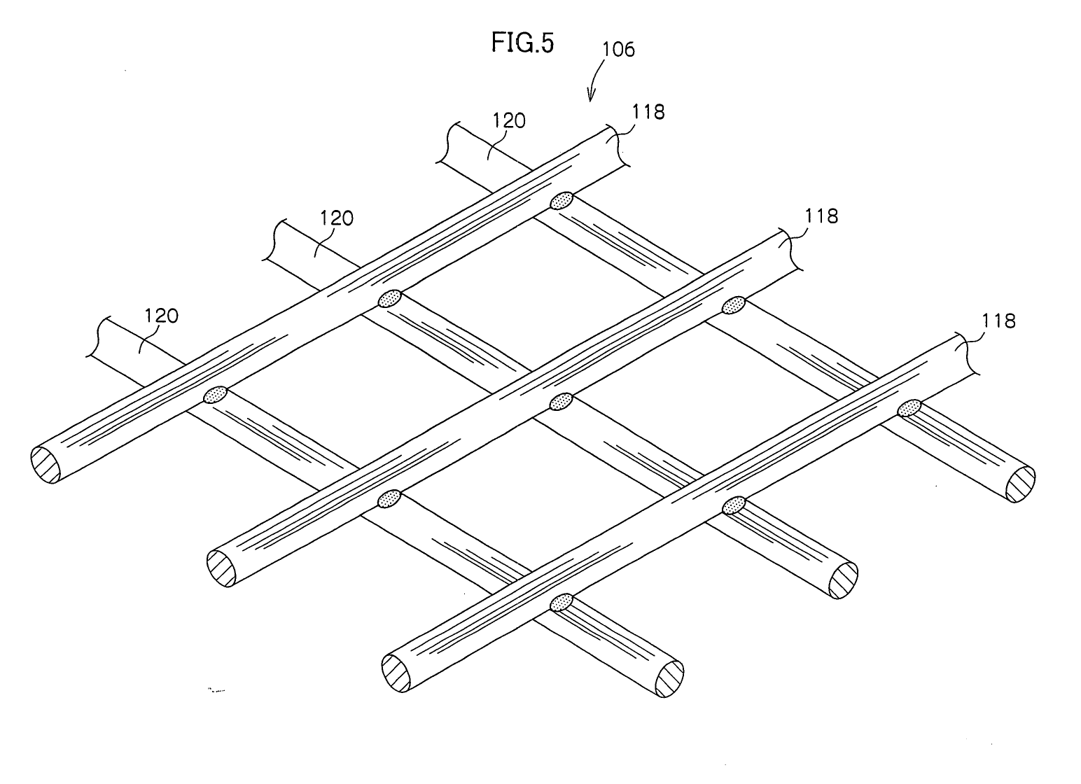

Further, the endless belt 106 may also be structured so that all of portions at which the warp 118 and the weft 120 intersect with each other is illustrated in FIG. 5. In the endless belt 106 shown in FIG. 5, the wefts 120 are made to place under the warps 118, and the portions at which the warp 118 and the weft 120 intersect with each other are bonded together with an adhesive or welded together, or firmly fixed by other means. Also in this structure, the warps 118 are positioned nearer the cut recording paper than the surfaces of the wefts 120 when set as the endless belt 106. In this endless belt 106 formed as shown in FIG. 5, the surfaces of the warps 118 along the longitudinal direction thereof on one side, at which the warps 118 are in contact with the cut recording paper P, can be brought into the state of a smooth straight line. Therefore, for example, even when the leading end of the cut recording paper P is intruded at the intrusion angle of 60 degrees and abuts against the warps 118, the leading end of the paper can move and slide more smoothly on the warps 118 of the endless belt 106 without being caught by the wefts 120. As a result, it is possible to further prevent the leading end of the paper from being damaged. Moreover, the structure of the endless belt 106 as shown in FIGS. 3, 4 and 5 in which at least one of yarns of the warp 118 or at least a portion of the warp 118 is surely placed over the weft 120 is not necessarily intended for all regions at which the warps 118 and the wefts 120 intersect with each other. As long as the above-described structure is provided in at least a region of the endless belt 106 in which region the cut recording paper P is conveyed on the endless belt 106, which region substantially corresponds to a dimension of the cut recording paper P in a width direction, the same effects are achieved.

Incidentally, in order to reinforce both side edges of the endless belt 106, a urethane protruding-string is welded at each of both side edges on the backside surface of the endless belt 106.

As shown in FIG. 2, an air blowing plate 114 which forms air blowing means is disposed in the drying device 61 so as to correspond to a straight-line portion of the endless belt 106 that forms a part of the conveying passage of the cut recording paper. The air blowing plate 114 is disposed so as to face the straight-line portion that forms the conveying passage of the endless belt 106, with a space interposed therebetween, in parallel with the straight-line portion. Further, the air blowing plate 114 is formed as a rectangular flat plate whose transverse dimension is larger than that of the endless belt 106. A large number of ventilation holes (air blowing holes) 116 are formed on the plate 114 with a predetermined distribution density.

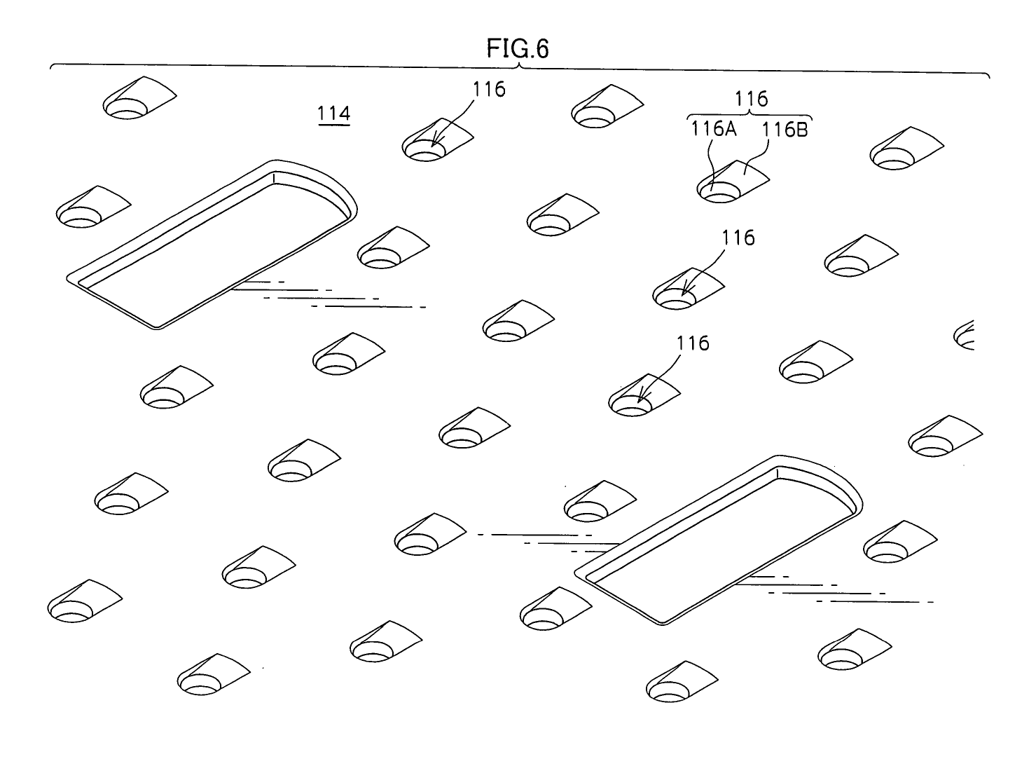

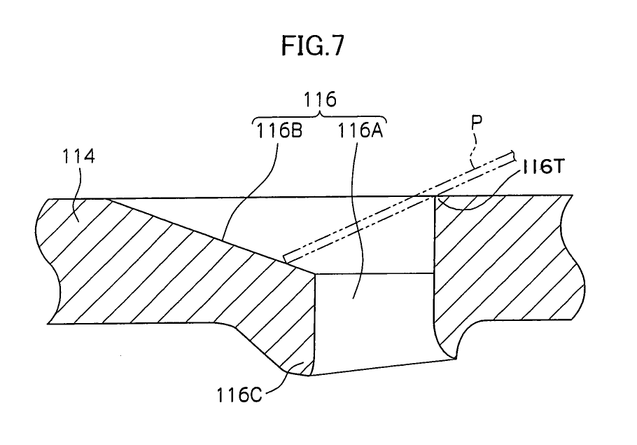

In the air blowing plate 114, each ventilation hole 116 is formed as shown in FIGS. 6 and 7 in order that the leading edge corner portion of the cut recording paper P should not be damaged by being intruded in and striking against the ventilation hole 116. That is, the ventilation hole 116 is at least formed by a through hole 116A and a guide inclined surface 116B. The through hole 116A is provided in the air blowing plate 114 so as to penetrate the plate 114, and the guide inclined surface 116B has a substantially rectangular shape when seen from the top and formed continuously to the downstream side in the conveying direction from the through hole 116A.

In the ventilation hole 116, for example, the through hole 116A is formed as a circular through hole of 4 mm in diameter, and the guide inclined surface 116B is formed so as to be tilted upward at the angle of 20 degrees from the intermediate position in a depth direction of the through hole 116A toward the downstream side in the conveying direction to a surface of the air blowing plate 114. Incidentally, dimensions and shapes of parts of the ventilation hole 116 are determined based on the maximum amount of curling at the leading edge corner portion of the cut recording paper P. That is, the ventilation hole 116 is formed such that, when the leading edge corner portion of the cut recording paper P is, as shown in FIG. 7, intruded, from a corner of the through hole 116A at the upstream side in the conveying direction, into the ventilation hole 116 in the state in which the leading edge corner portion of the paper is curled at the maximum amount of curling, the leading edge corner portion of the cut recording paper P abuts against the guide inclined surface 116B and the intrusion angle T at a time of the leading end of the paper abutting against the guide inclined surface 116B becomes 60 degrees or less.

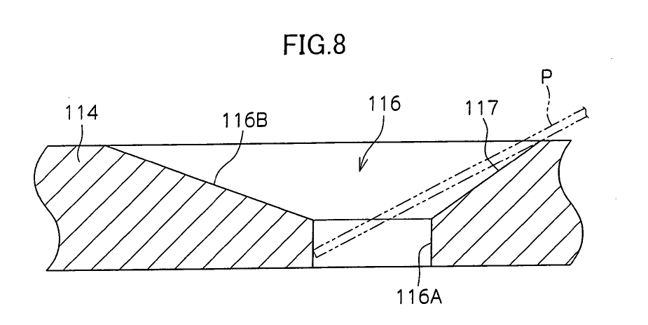

Incidentally, in a comparative example in which a guide inclined surface 117 is also formed at the upstream side of the through hole 116A in the conveying direction, for example, as shown in FIG. 8, when the leading edge corner portion of the cut recording paper P is intruded into the ventilation hole 116, across the guide inclined surface 117 positioned at the upstream side of the conveying direction, in the state of being curled at the maximum amount of curling, the leading edge corner portion of the cut recording paper P abuts against and is caught by a vertical surface of the through hole 116A. As a result, the leading edge corner portion of the cut recording paper P would be damaged.

However, in the present embodiment, as shown in FIG. 7, no guide inclined surface is formed at the upstream side of the through hole 116A in the conveying direction. Therefore, the leading edge portion of the cut recording paper P is raised above the guide inclined surface 116B in such a manner that the cut recording paper P is supported by the upper portion 116T of the vertical surface of the through hole 116A from the lower surface of the cut recording paper P. As a result, the leading edge corner portion of the cut recording paper P is guided so as to slide on the guide inclined surface 116B and is move away from the ventilation hole 116 without suffering any damage.

Further, the air blowing plate 114 can be produced by punching out a metal flat plate by press working to form the ventilation holes 116. When the air blowing plate 114 is produced in such a manner as described above, a flash-like protruding portion 116C that remains protrusively in the form of so-called “flash” can be formed on the back side of the plate 114 when each ventilation hole 116 is formed by press working. In the present embodiment, with the flash-like protruding portion 116C being remained on the backside surface of the air blowing plate 114, manufacture of the air blowing plate 114 is completed, That is, the air blowing plate 114 is manufactured without carrying out a finish working for flattening out the flash-like protruding portions 116C formed on the backside surface of the air blowing plate 114, using press working once again. As a result, the finished air blowing plate 114 can be maintained in a planar state. Incidentally, in the case in which, when manufacturing the air blowing plate 114, if a finish working for flattening out the flash-like protruding portions 116C formed on the backside surface of the air blowing plate 114 is carried out by press working once again, there may be problems in which the air blowing plate 114 may deform so as to warp. Therefore, in this case, a process for eliminating warping of the air blowing plate 114 is further required. Accordingly, the air blowing plate 114 can be manufactured as a finished product with the flash-like protruding portions 116C remaining on the backside surface of the air blowing plate 114, and therefore, a low-cost air blowing plate 114 can be provided without requiring the process for eliminating warping.

The drying device 61 shown in FIG. 2 is provided with a suction case (not shown), serving as a part of air blowing means, to which a dry-air suction duct is connected, so as to cover a portion of the endless belt 106 at the side thereof opposite to the side at which the air blowing plate 114 is disposed.

Further, a dry-air blowing case (not shown) serving as air blowing means is disposed so as to cover an outer portion of the air blowing plate 114. Although not shown, the air blowing case is formed in the shape of a thin-walled box, and an air blowing duct connected to an air blower is connected to a portion of the air blowing case. The air blowing duct has a heater unit incorporated therein. In the air blowing means, air fed from the air blower into the air blowing duct is heated by the heater unit to produce hot dry air, and thereafter, the hot dry air is supplied into the air blowing case, the dry air is blown from the ventilation holes 116 of the air blowing plate 114 against the cut recording paper on the endless belt 106 to thereby dry the cut recording paper, and further, the state in which the cut recording paper is pressed onto the endless belt 106 by the dry air is maintained in order to convey the cut recording paper.

In the air blowing means, the dry air blown against the cut recording paper is circulated in such a manner that the dry air comes into the dry air suction case through mesh opening portions of the endless belt 106 and the dry air is taken into the air blower by being sucked from a suction opening provided in the suction case.

Further, in the drying device 61 shown in FIG. 2, for example, the endless belt 106 is allowed to move around so as to correspond to the conveying direction of the cut recording paper by, for example, connecting an output shaft of a drive motor (not shown) to a nip roller 110A serving as a drive roller, which nip roller 110 A is slightly larger than other nip rollers 110, and driving the drive motor. Thus, the cut recording paper pressed against the endless belt 106 by the dry air is conveyed.

The cut recording paper conveyed to a turning portion at the conveying guide member 104 at the down stream side in the conveying direction is fed in three nip rollers 110 by the endless belt 106 and conveyed to the re-sorting section 62 on the conveying path 16.

When the cut recording paper is conveyed by the three nip rollers, the emulsion surface of the cut recording paper is in the state immediately after heated dry air is blown against the surface (a so-called “softened state”). Accordingly, if the cut recording paper is nipped too strongly, the cut recording paper may be damaged, or marks may be formed on the cut recording paper by the nip rollers pressing the paper against the endless belt 106.

To this end, in the drying device 61, spring pressure with which the cut recording paper is pressed by the nip rollers 110 is set in a range from a minimum spring pressure, with which conveying of the cut recording paper by the nip rollers is possible, to a maximum spring pressure, with which conveying of the cut recording paper by the nip rollers is possible in a state of no visually recognizable mark or scar remaining on the cut recording paper.

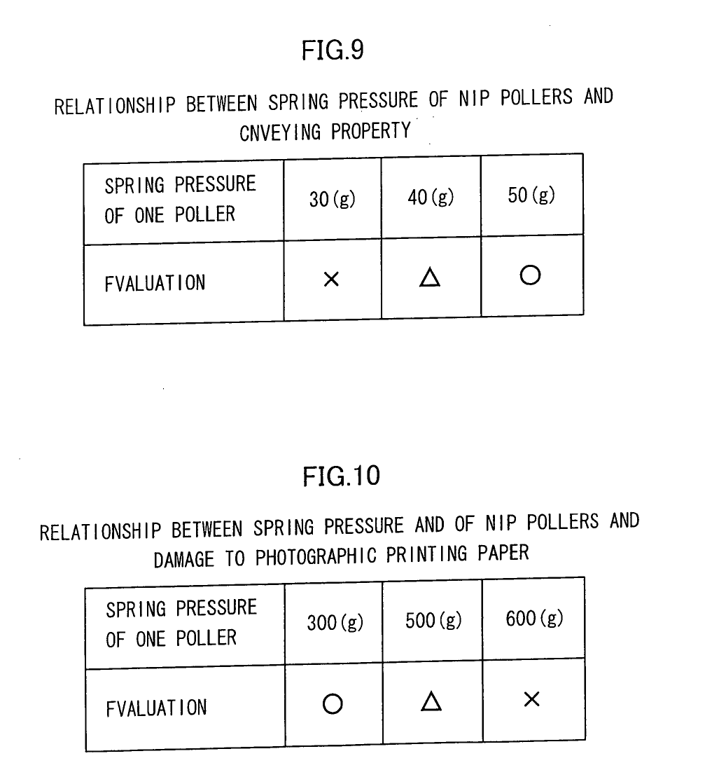

The minimum spring pressure that allows conveying of the cut recording paper is determined by experiments, and the results thereof are shown in FIG. 9. It can be seen from the results that as long as the spring pressure of one of the nip rollers 110 is set to be 40 g or more, the cut recording paper can be conveyed approximately properly. Incidentally, it is more preferable that the spring pressure of the one of the nip rollers 110 is set to be 50 g or more.

Further, the maximum spring pressure with which no mark or scar visually recognizable remains on the cut recording paper is determined by experiments, and the results thereof are shown in FIG. 10. It can be seen from the results that as long as the spring pressure of one of the nip rollers 110 is set to be 500 g or less, the cut recording paper can be conveyed properly in such a manner that no mark or scar that can be recognized visually remains thereon. Incidentally, it is more preferable that the spring pressure of the one of the nip rollers 110 is set to be 300 g or less.

As shown in FIGS. 1 and 2, in the processor section 14, the cut recording paper discharged from the squeezing device 100 would be made to abut against and to be intruded into the surface of the endless belt 106 at a relatively severe intrusion angle of 60 degrees. In this case, the photosensitive material conveying speed in the drying device 61 is set higher by a predetermined amount so as to further reduce the possibility that the leading end of the cut recording paper may be damaged. In the processor section 14, when the intrusion angle of the cut recording paper with respect to the endless belt 106 is set to be 60 degrees, the photosensitive material conveying speed in the drying device 61 is set to be higher than that in the squeezing device 100 by 2%. In other words, when the cut recording paper is made to abut against and to be intruded into the endless belt 106 in the conveying system of the drying device 61, the conveying speed of the endless belt 106 is set to be higher than the conveying speed of the conveying passage which sends the cut recording paper P into the drying device 61 by 2%.

Due to the above-described structure, when the leading end of the cut recording paper which is from the squeezing device 100 is made to abut against and to be intruded into the endless belt 106, the leading end of the cut recording paper is made in contact with the endless belt 106 in the state of being guided so as to slide slowly on the warps 118 of the endless belt 106, thereby lessening the impact at the time of intrusion thereof. Accordingly, it is possible to more reliably reduce the possibility that the leading end of the cut recording paper may be damaged.

Next, the operation of the output machine 10 according to the present embodiment having the above-described structure will be described. In the output machine 10, by the control section 17 to which a print instruction is given, the photosensitive recording paper 34 is pulled out from the magazines 20a, 20b installed in the feeding section 20 in accordance with a print size, and the cut recording paper is formed by driving the cutter 36. The cut recording paper is forwarded to a backside printing section 22, in which various information is recorded thereon, and thereafter, skew or the position in the transverse direction of the cut recording paper is adjusted in the registration section 24. The cut recording sheet conveyed through the registration section 24 is conveyed to the image recording section 26, and a latent image is formed so as to be subjected to scan-exposure by a light beam LB modulated based on image data from the image processing section 13.

The cut recording paper after the latent image has been recorded thereon is forwarded to the sorting section 30 through the sub-scan receiving section 28. In the sorting section 30, when cut recording paper larger than a predetermined size is conveyed, the cut recording paper is conveyed to the discharging section 32 in the state of a single line without being arranged in two lines. When cut recording paper is smaller than the predetermined size, cut recording papers are conveyed in such a manner as to be arranged in two lines.

The cut recording paper conveyed to the discharging section 32 is conveyed sequentially in a constant conveying direction by nip-releasable conveying roller pairs, and after a predetermined time period, from a time that the leading end of the cut recording paper is detected by the recording paper sensor to a time that the cut recording paper arrives to a speed adjustment roller pair, has passed, the conveying speed of the speed adjustment roller pair is reduced, and the speed is changed according to the processing ability of the processor section 14, with the nip rollers of the conveying roller pair being moved to a release position, for absorbing a loosed portion of the cut recording paper which loosed portion is due to the reduction of speed.

In the processor section 14, a photographic print is formed by carrying out development, fixing and washing for the cut recording paper on which a latent image has been recorded, and by visualizing the latent image.

The cut recording paper processed in the processor section 14 is conveyed to the drying device 61 after water adhering thereto is squeezed off by the squeezing rollers 102 of the squeezing device 100. In the drying device 61, the cut recording paper is conveyed on the endless belt 106. In this drying device 61, dry air sent from the air blower and heated by the heater unit is substantially uniformly blown out from all of ventilation holes 116 of the air blowing plate 114. Due to the dry air, the cut recording paper on the endless belt 106 is pressed against the endless belt 106. Accordingly, the cut recording paper is subjected to drying processing while it is being conveyed between the air blowing plate 114 and the endless belt 106 by circle movement of the endless belt 106. Moreover, at the cut recording paper on the endless belt 106, the dry air is sucked by a suction duct, and therefore, it is reliably conveyed in such a manner as to be pressed against the endless belt 106.

In this way, the cut recording paper is reliably pressed against the endless belt 106 by air blowing from the ventilation holes 116 of the air blowing plate 114, and by air suction from the suction case. Therefore, even if a curling portion is formed on the cut recording paper by being dried, the curling portion is pressed down. Further, even if a strongly curling portion is generated for some causes and an edge corner of the cut recording paper P is about to intrude into the ventilation hole 116 due to the curling, the edge corner of the cut recording paper is guided so as to move outside by the guide inclined surface 116B. Accordingly, jamming of cut recording paper, paper edge being folded and the like are reliably prevented.

As shown in FIG. 1, in the processor section 14, the cut recording paper having been subjected to drying processing in the drying device 61 is forwarded to the re-sorting section 62. In the re-sorting section 62, the cut recording papers conveyed in two lines are returned into a single-line state. In the sorter 63, a plurality of cut recording papers conveyed from the re-sorting section 62 are outputted for each print job, and stored.

It will be of course appreciated that the present invention is not limited to the above-described embodiment and is also applicable to a printer processor of such a type as to directly record an image using light projected from a film, or the like.

What is claimed is:

1. An image forming apparatus equipped with a drying device, the drying device comprising:
a conveying system for conveying a photosensitive material, at which an endless belt is wound on a plurality of winding rollers; and
an air blowing section for drying a photosensitive material on the endless belt by blowing dry air against the endless belt,
wherein the photosensitive material can be conveyed by the endless belt in a state in which the photosensitive material is pressed and maintained on the endless belt by means of dry air, and
wherein the endless belt includes a mesh structure in which warps extending along a direction in which the photosensitive material is conveyed intersect with wefts, and
at least in a region of the endless belt on which region the photosensitive material is placed, at least a portion of the warp is positioned nearer a surface of the photosensitive material, which surface faces the endless belt, than the weft in each portion at which the weft intersects with the warp.

2. An image forming apparatus according to claim 1, wherein when the photosensitive material abuts against and intrudes into the endless belt in the conveying system of the drying device, a conveying speed of the endless belt is made higher than a conveying speed of a conveying passage by which the photosensitive material is conveyed into the drying device.

3. An image forming apparatus according to claim 1, wherein the warp comprises a plurality of yarns.

4. An image forming apparatus according to claim 3, wherein the warp is formed by weaving a plurality of twisted yarns.

5. An image forming apparatus according to claim 3, wherein the weft passes through between the plurality of yarns of the warp in each portion at which the weft intersects with the warp.

6. An image forming apparatus according to claim 1, wherein the warp is mounted onto the weft so as to be positioned nearer the surface of the photosensitive material than the weft in each portion at which the weft intersects with the warp.

7. An image forming apparatus according to claim 6, wherein the warp is fixed to the weft by an adhesive member.
